(19) United States
(12) Patent Application Publication
(10) Pub. No.: US 2007/0088729 A1
(43) Pub. Date: Apr. 19, 2007

(54) Flexible history manager for manipulating data and user actions

(75) Inventors: Mariana C. Baca, Cambridge, MA (US); Ian T. Fischer, Somerville, MA (US); Alister Lewis-Bowen, Cambridge, MA (US); Louis M. Weitzman, Brookline, MA (US)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 11/251,016

(22) Filed: Oct. 14, 2005

(51) Int. Cl. G06F 7/00

(52) U.S. Cl. 707/101

(57) ABSTRACT

A data file or data record is operated on in order to transform the data record by user actions. A history record of actions is accumulated. Various operations are performed on selected actions of the history record to modify the sequence of actions of the history record. Preferably the changed history record actions are applied to the data record to produce desired results.

### FIELD OF THE INVENTION

The present invention relates to the field of computer software, more particularly to managing or manipulating historical file changes.

### BACKGROUND OF THE INVENTION

U.S. Pat. No. 6,108,668: “Method and system for undoing edits within selected portion of electronic documents” filed Apr. 18, 1997 incorporated herein by reference, provides a method and system, to be utilized with an editing system having electronic document editing capabilities, which provides an ability to selectively undo previous edits performed upon a selected particular portion of an electronic document. The method and system provide the forgoing objects in the following manner. Previous edits performed within an electronic document are stored. A contiguous block of data within an electronic document wherein the stored previous edits are to be undone is selected. In response to user input, part or all of any of the stored previous edits that have been done within the selected contiguous block of data are then undone.

U.S. Pat. No. 6,111,575: “Graphical undo/redo manager and method” filed Sep. 24, 1998 incorporated herein by reference, a graphical undo/redo manager that provides a graphical indication of multiple tasks that were recently performed. A user may undo multiple tasks in one step by selecting a task the user wishes to revert to, and the graphical undo/redo manager then undoes all the commands that were done subsequent to the selected task, taking the computer program to a desired state in only one user operation. In similar fashion, a user may redo multiple tasks in one step by clicking on a selected subsequent task (that was previously undone) that the user wishes to go forward to, and the graphical undo/redo manager then redoes all the commands between the last undo and the selected task, including the selected task. In addition, the graphical undo/redo manager provides for collapsing multiple tasks into a marker, either automatically when certain commands are executed in the computer program or upon command by a user for future reference.

U.S. Pat. No. 6,185,591: “Text edit system with enhanced undo user interface” filed Jul. 29, 1997 incorporated herein by reference provides an edit system having an enhanced undo interface, that permits the selective display of undo elements intermixed in the edit view of the document with actual text elements and positioned relative to the affected text The user may select any undo element and selectively restore changes to the text. A series of user interface enhancements provide the user with a flexible set of capabilities for manipulating and assessing changes to a document.

While the ability to undo actions in a program has been known in the prior art as well as the ability to undo a series of actions in a program, no-one has offered users of a given program the ability to arbitrarily modify, rearrange, undo, and redo any action in the history of actions performed during the course of operating the program, much less the ability to do so across multiple use sessions of the program. Nor has anyone offered the ability to turn the same arbitrary series of actions into a script for that program. The ability to undo and redo actions is a powerful and oft-used tool in any reasonably designed application, but there is much more that could be done with a history of actions. Currently, programs offer the user the ability to undo and redo the n most recent actions in series of actions, but if n is exceeded, the action is forgotten, which can make life difficult for the user, if by some chance a mistake was made at the n+1^{st} prior action or before. A solution embraced by some applications is to allow an “unlimited” number of undo operations, starting from the time a given file is opened or created, but only within the limits of a single use session. This extension is certainly an improvement, but it still does not solve all the problems of manipulating data in a program. Adobe Photoshop, for example, enable a fixed undo for a given editing session. In addition to this history, it also has a separate scripting or actions facility.

One situation where this solution is inadequate is the case where a file is received from another user of the program, and the receiver wants to discover how exactly the file was made—what was the process that resulted in the file's final state. To make this more concrete, consider the case of a 3d-manipulation tool. It becomes extremely difficult to guess and recreate a series of transformations that led to the creation of even a simple 3d object once the number of steps passes a relatively low threshold. The same is the case for image manipulation—a series of filters and selections is exceptionally difficult to reproduce even for experienced users of advanced image manipulation applications. Thus, not maintaining a complete and accurate history of transformations made on a given object results in loss of useful data that could be shared between users, or even simply between use sessions.

A method is needed to improving handling data history transformation of data records.

### SUMMARY OF THE INVENTION

The goal of the History Manager is to give the user a completely modifiable history of a given data set from the creation of the data set to the current moment. This invention could be applied to individual data items (e.g., images) or a sequence of data items. To achieve this goal, the History Manager needs to offer the user a specific set of tools through a certain general interface, which in combination constitute the invention. Firstly, the History Manager would offer the user the ability to toggle arbitrary actions in the history—this differs dramatically from the simple ability to undo and redo the n most recent actions. Here, if the user wishes to remove the ith action, it is not necessary to remove all n−i+1 actions after it. The user can simply click a check box or some equivalent user interface item and have the effect of the action removed from the history, resulting in the re-computation of the output from the nearest prior active action through the most recent active action, including the effects of all active actions in between.

Secondly, the History Manager would permit the user to modify the attributes of any given action in the history, which would then result in the re-computation of all the active actions from that point forward through the current action. This feature is also dramatically different from other undo options in that a given command issued by the user can only be undone, not modified. Previously, if the user wants to see the results of changing a given attribute from an action early in the history on the output of all of the following actions, the user has to go back to the action initially made and remove it and all of the actions that follow it and recreate all of the work that was previously completed. With the History Manager, however, the user can simply change the attribute of the action without having to recreate any other work.

The next major use of the History Manager would be script creation. Currently, in many applications, if the user knows in advance that a script needs recording, it is possible to select a “Record Macro” option that will record some series of actions that could later be reused. However, such foresight is not always possible. It is much more convenient to simply do a series of actions, and after modifying the actions to achieve the desired result, simply click a button that turns selected actions into a script. Also, since this script is created directly from the history of actions, the individual steps can easily be modified graphically—simply deselect whatever actions are not needed, rearrange actions into the best order, and modify the action attributes before or after creating the script with the History Manager. In other words, the user can create a script from a discontinuous set of actions without knowing in advance that the script will be needed. In addition, the saved script could be edited by a user outside the context of the History Manager or its host application. The user could edit a text file (e.g. an XML file) to reorder the actions or otherwise modify the actions or the attributes.

Furthermore, the user may want to be able to annotate the complete history or individual actions in the history with metadata describing the step—perhaps with the rational as to why the step was taken. This feature may in particular be useful in the creation of tutorials. In essence, the tutorial creator could simply do all the steps required for the tutorial, and then go back and comment as to why a given step was necessary. At that point, the file itself would become the tutorial—a person who wants to know how to create a particular result would simply open the file and review the history and the metadata associated with the history and its individual actions. This feature is of particular interest because it can greatly aid new users in learning an application, which in turn increases the possibility that the application will be useful and successful.

It is therefore an object of the invention to manage data record actions by accumulating in a first action history record, a first sequence of actions performed on a first data record, selecting one or more first actions from the first action history record, and performing a manipulating operation on one or more of the first actions, the manipulating operation modifying the first sequence of actions to produce a second sequence of actions.

It is a further object of the invention to perform the second sequence of actions on the first data record to produce a second data record.

It is yet another object of the invention to create a second action history record associated with the second data record and save the second action history record or display the second data record.

It is yet another object of the invention create a marker in the first action history record, the marker comprising information for locating the second action history record and the second data record.

It is yet another object of the invention create an index record for locating the second data record and save index information in the first action history record.

It is yet another object of the invention to perform the modifying operation by performing any one of the further steps consisting of moving a first action from a sequential position of the first sequence of actions to a new sequential position of the first sequence of actions, inserting a second action into the first sequence of actions such that the third action comprises an action sequence preceding an action of the first sequence of actions, inserting a program module into the first sequence of actions, modifying the sequence of the first sequence of actions, undoing one or more of the first actions, redoing one or more of the first actions, or operating on one or more of the first actions. Furthermore, the operating step consisting of any one of enabling a first action, disabling a first action, adding a new action, deleting a first action, copying a first action, pasting a first action, changing the first action sequence, modifying parameters of a first action, or annotating an action.

It is yet another object of the invention wherein the modifying operation is performed responsive to a GUI event.

It is yet another object of the invention to select one or more actions of the group of first and second actions, generate a program module reproducing effective functionality of the selected one or more actions, and save the generated program module.

It is yet another object of the invention wherein the generated program module comprises a script.

It is yet another object of the invention to accumulate in the first action history record, the first sequence of actions performed on the first data record across sessions, the sessions comprising any one of a user session, a program session, a communications session or a computer session.

It is yet another object of the invention to, responsive to a GUI user action, perform an action of the first sequence of actions.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts components of prior art computing system;

FIG. 2 depicts an example network according to the prior art;

FIG. 3 depicts an overview of an example user interaction;

FIG. 4 depicts details of an example user interaction with the History Manager;

FIG. 5 depicts an example re-rendering according to the present invention;

FIG. 6 depicts the logic of deciding when to create a snapshot;

FIG. 7 depicts the use of a snapshot by the system;

FIGS. 8A-8D depict example GUI actions of the present invention; and

FIGS. 9A-9H depict an example sequences of rendered actions according to the present invention.

The detailed description explains the preferred embodiments of the invention, together with advantages and features, by way of example with reference to the drawings.

### DESCRIPTION OF PREFERRED EMBODIMENTS

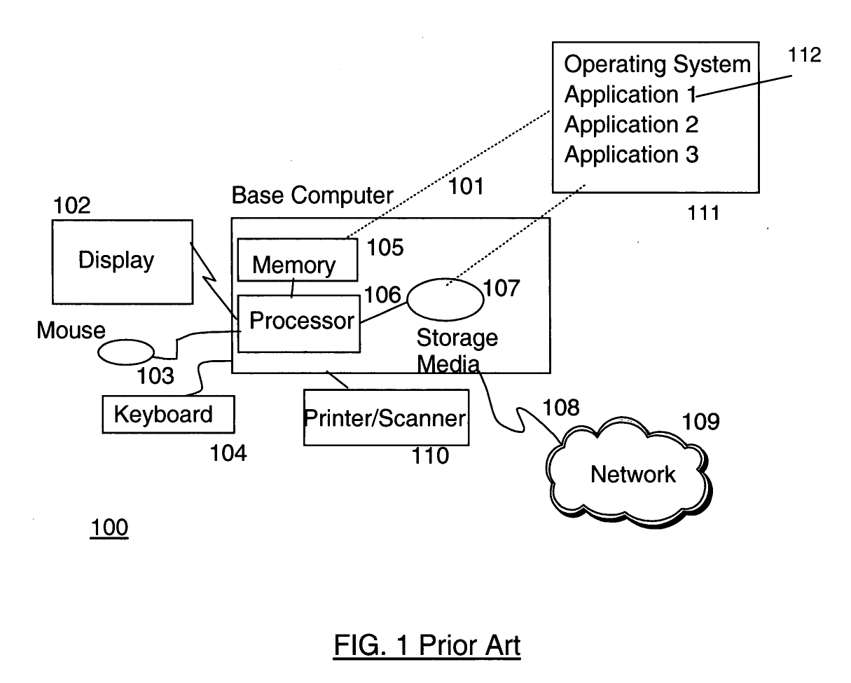

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

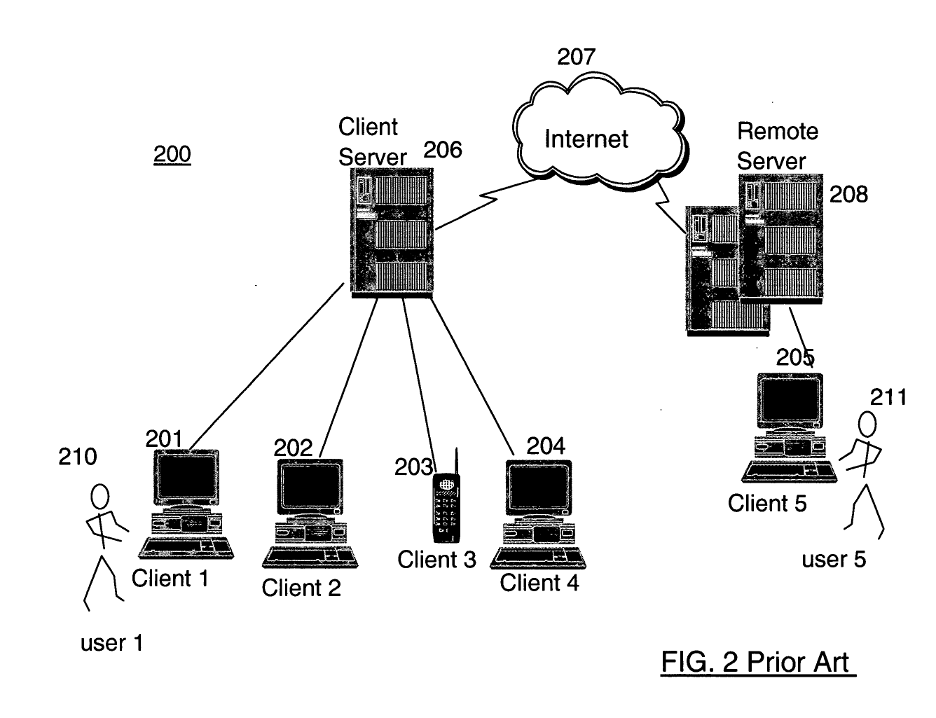

FIG. 2 illustrates a data processing network 200 in which the present invention may be practiced. The data processing network 200 may include a plurality of individual networks, such as a wireless network and a wired network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zSeries® 900 Server available from IBM Corp.

Software programming code which embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed (deployed) on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

In the following detailed description of the present invention, numerous specific details are set forth in order to provide a thorough understanding of the present invention. However, it will be obvious to one skilled in the art that the present invention may be practiced without these specific details. In other instances well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, step, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

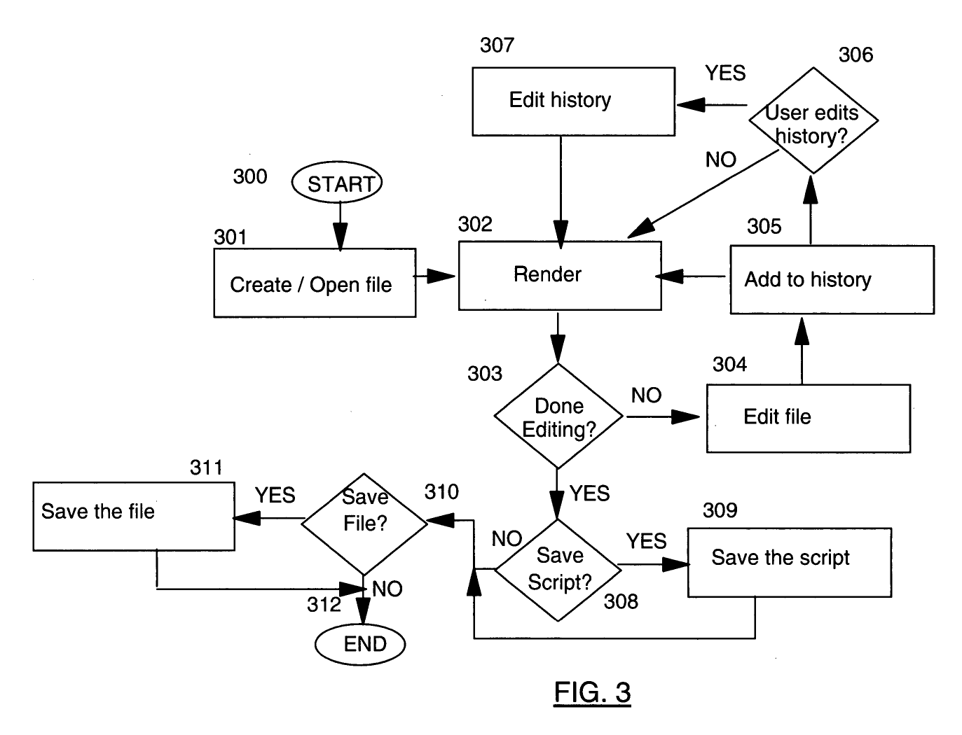

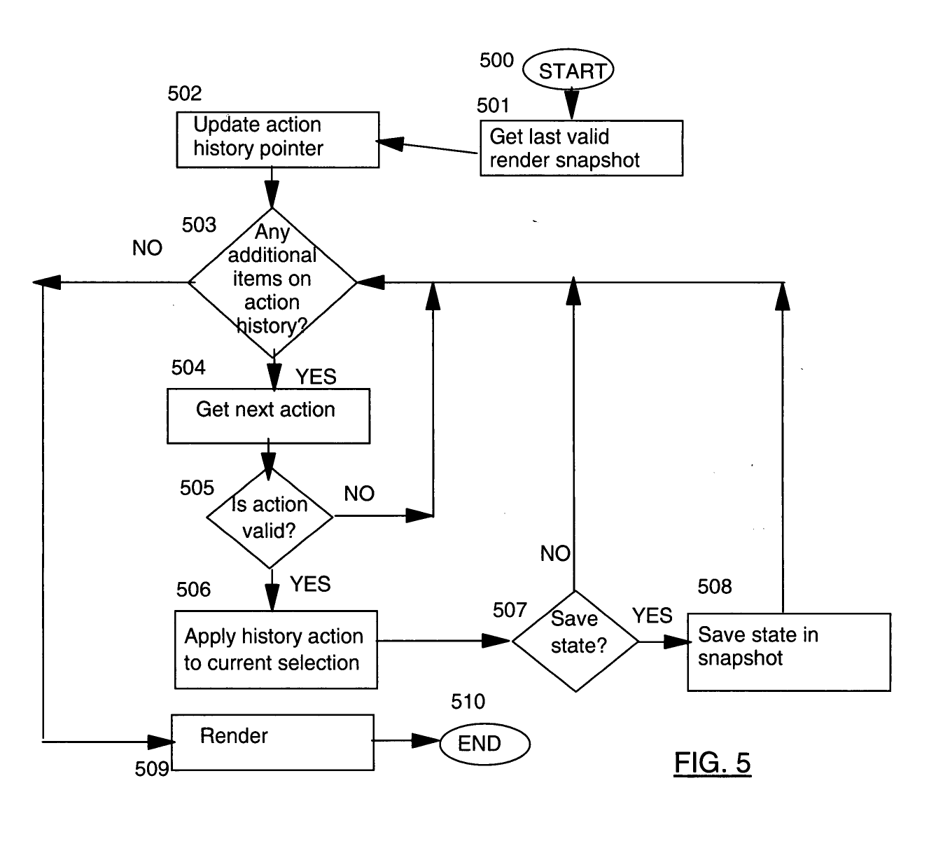

In FIG. 3, the overview of the interaction between the user and the program which uses the History Manager is described. The user starts either by creating a new file, or opening an existing file 301. This file is rendered accordingly 302 if it is a new file, then the default rendering appropriate to the program is performed, but if it is a previously created file, then the rendering procedure shown in FIG. 5 is performed. After the initial rendering 302, the user enters 303 into an editing loop, in which the user performs edits (“actions”) on the file 304, as well as edits on the action history 307. Once the file is in a satisfactory state, or the user needs to discontinue work 303, the user has the option 308 of saving the action history, or some subset thereof, as a script 309 that can be used as an independent action in later uses of the program. The user may preferably save the file 311.

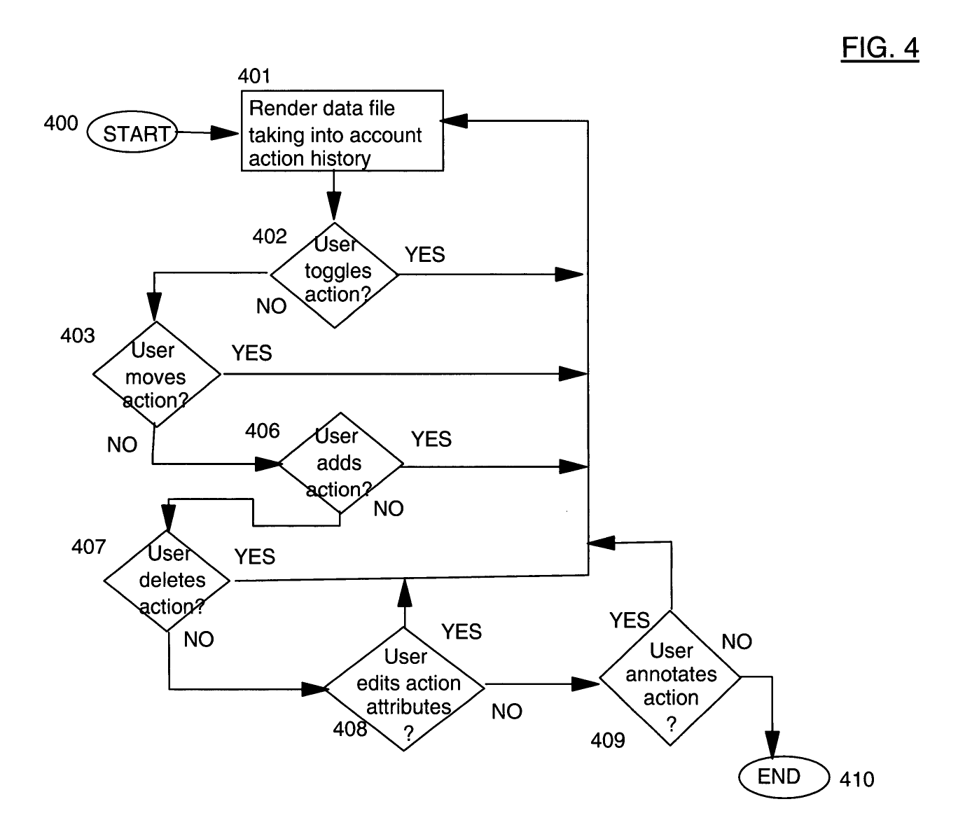

In FIG. 4, details of the interaction between the user and the History Manager can be seen. At this point, the file is rendered for the user 401, taking into account what the current list of active actions contains, the details of which can be found in FIG. 5. While interacting with the History Manager, the user can choose 402 to toggle a given action's use 402 i.e., turn a selected action from anywhere in the list of actions either on or off. A standard user interface widget to do this is a checkbox. The user can optionally move 403 a selected action into a new position anywhere in the list of actions. The user can also insert or add 406 an action at any point in the list of actions. The user can also delete 407 an action from any point in the list of actions. The user can also select an action from anywhere in the list of actions and edit 408 any attributes that action might have or copy and paste it into the list. Finally, the user can also annotate any given action in the list of actions (e.g., to explain why that action was taken) 409. After any of these editions of the action list, except for annotation, the file is re-rendered for the user 401, according to FIG. 5.

In order to avoid computationally expensive operations, snapshots of the file are periodically saved throughout the life of the editing process. This may be user initiated or automatically created. In FIG. 5, details of a preferred rendering process for a program using the History Manager can be seen. First, the last usable snapshot of the file is determined 501, using such techniques as unique identifiers or index of the snapshots and of the various actions which contributed to the snapshot, and recording them into a table, i.e., hashing. The pointer to the next action to be processed in the list of actions is updated 502 to the next enabled action after the last action that contributes to the selected snapshot. Then the program enters a loop to process any remaining actions on the list of enabled actions. If 503 there are more actions to process, the next enabled action is selected 504 and tested for validity 505 against the given context of the program (e.g., “can this action be performed on the current selection?”, or “does this action refer to an object that was previously deleted?”). If it is valid, the action is applied to the current context 506. A test is then performed to determine whether or not the current state should be made into a snapshot 507, such as checking to see how long the action took to perform, how long it has been since the last snapshot was created, or if the next action is non-reversible. If it is necessary to create the snapshot, that is done 508, and the program returns to the beginning of the loop. If there are no more actions on the stack at this point, the current context of the program is rendered 509.

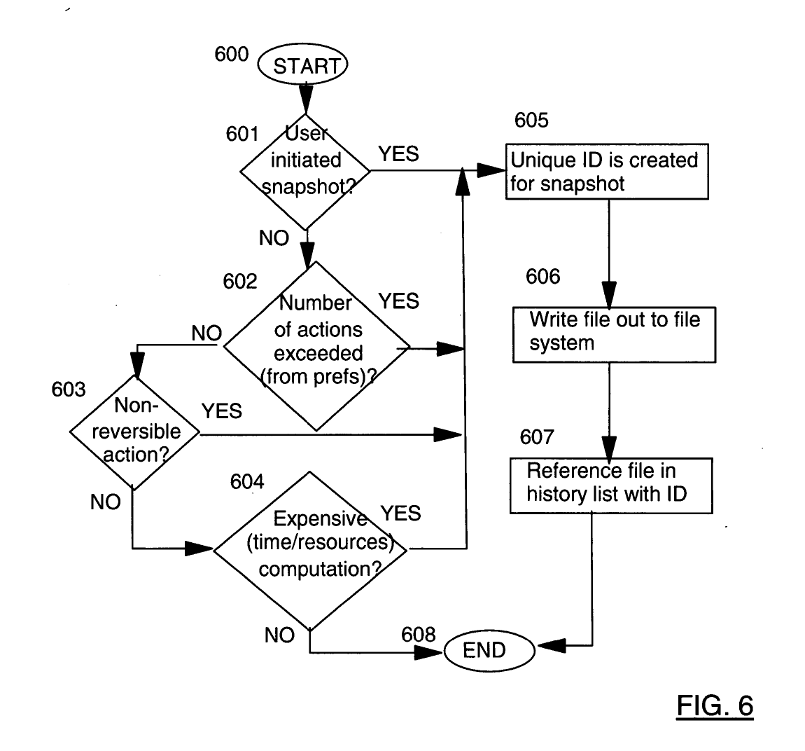

FIG. 6 illustrates the process of creating a snapshot which can be used to render the file at a later time. These snapshots are intermediate steps used to reduce the computation as the user interactively moves through the history list. These are used internally for improved performance and the user does not necessarily need to know that the snapshots even exist. Described here are four examples of ways in which to initiate a snapshot; others are possible. The user can 601 explicitly request a snapshot to be created 605 606 607. If 602 a number of actions has exceeded a maximum number, a snapshot will automatically be created. This maximum would typically be stored in a preference setting. Another automatic way to produce a snapshot is if 603 a non-reversible action is about to be taken. These actions can be identified by the application and stored on a list of actions in which a snapshot should be taken before the action is performed. Another way to automatically create a snapshot is if 604 an expensive computation is about to take place. This could be expensive in terms of resources or time. Preferably if one of these conditions is true, then a unique identifier or index is created 605 for the snapshot. This could be used internally or in the naming of the file. Then, the file is written 606 out to disk (long term storage) and used across sessions and network connectivity. The history list uses this unique ID to reference 607 the file within the history list.

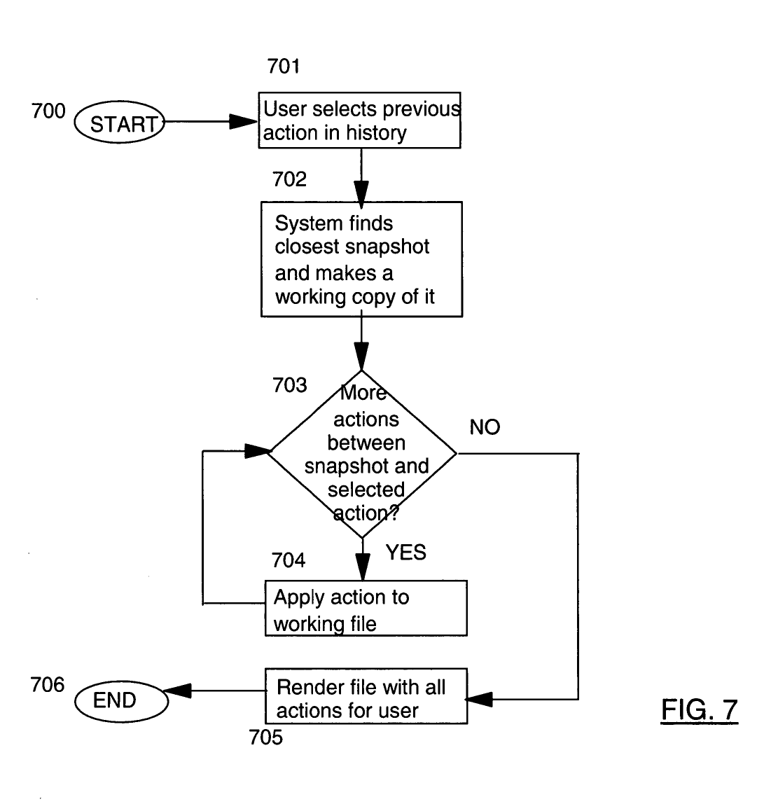

FIG. 7 illustrates the process of using a snapshot to reduce the computation when moving through the history list to view different stages of the actions. This is initiated by the user selecting 701 an action within the history list. The system then determines 702 the closest snapshot that can be used to construct the file. Using the snapshot as the starting point, the system then applies 704 the actions from the snapshot to the selected action in the history list. This continues until 703 all selected actions have been applied to the file. The system then renders 705 the current state of the file for the user.

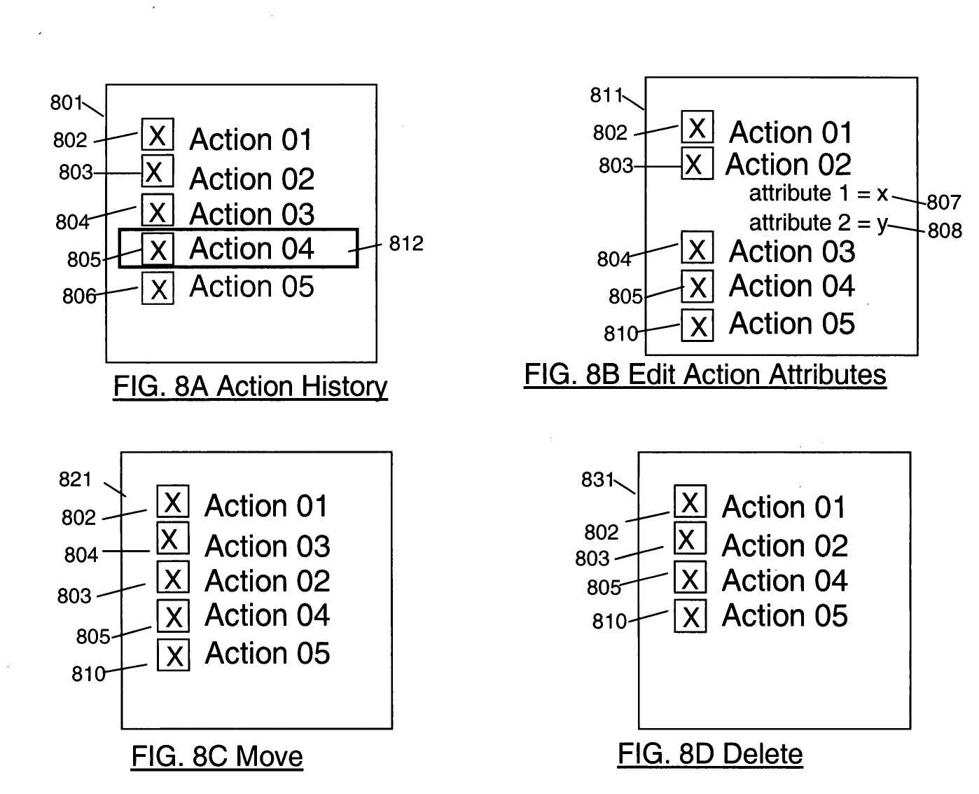

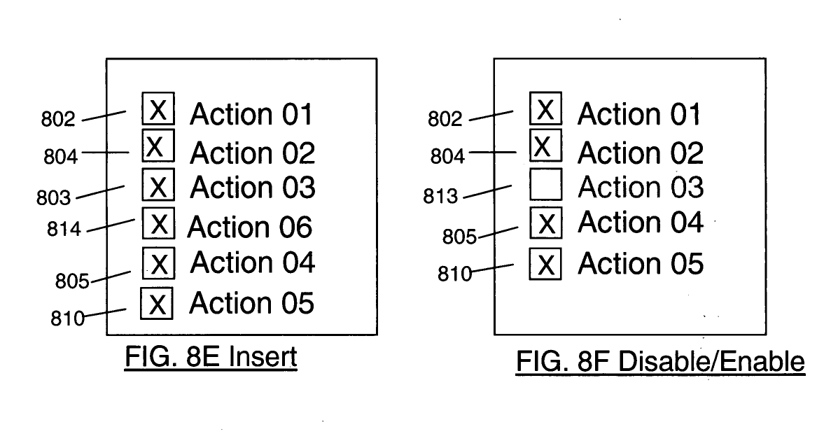

FIG. 8 shows some of the possible uses of the History Manager. In FIG. 8A 801, the history pointer (highlight 812) is set to an action 805 (Action 4) 805 not at the end of the action stack of actions 802 803 804 805 806. Action 5 806 is enabled (as shown by the checkbox), but not taking effect (as shown by the gray color of the text)—the user wants to see the result of all actions up to and including Action 4, but excluding Action 5.

In FIG. 8B 811, the user has opened the attributes 807 808 of Action 2 803 in order to edit them. Note that all actions after 2 804 805 810 are still active—the user merely wishes to change the attributes of some earlier action to see its effect given all actions that were taken after Action 2 803.

In FIG. 8C 821, the user has moved Action 3 804 to occur between Action 1 802 and Action 2 803, perhaps to explore the effect of a different ordering of transformations on an image or 3D data.

In FIG. 8D 831, the user has deleted Action 3 804 altogether, having decided that it was not appropriate edition to the content of the file.

In FIG. 8E, the user has inserted a new Action 6 814 into the list which adds additional modifications to the data file. Subsequent actions are recomputed taking into account the new action.

In FIG. 8F, the user has disabled Action 3 813 by removing the check in the user interface widget box to the left of the action label. This keeps the action in place within the action list and allows the user to re-enable the action at a subsequent time.

When a user adds an action (through whatever interface is appropriate), that action is either added to the end of the list of actions in the history, or added after the currently selected action in the history. All computations affected by the action are redone—in the case of an appended action, merely the action itself would be computed. In the case of an inserted action, however, all active actions from the inserted action through the last active action would be recomputed. At any point, actions can be moved from their current position to a new position in the history, which again results in the minimal re-computation. Also, at any point an action can be deactivated or reactivated by a toggle, such as a check box (FIG. 8F). Again, the minimal re-computation is accomplished.

An individual action's properties can be modified, most likely through a button or a right-click menu, either of which would display an action-specific dialog to edit the properties. Again, any necessary re-computations would be done after the modifications.

When a user has an acceptable series of actions, the user may choose to turn the actions into a script. This would be accomplished with a simple button click, and the script would be saved to some user-accessible location, and perhaps opened for editing.

Finally, if the user wishes to give insight into why a given action was performed, the user can select an action, and annotate the action. A typical interaction is to use a right-click menu for this operation. Some sort of visible indication of the annotation would be displayed so that users can know what steps have comments. Because a set of history actions can be saved as a script, they can be used across sessions of one application or shared between users to support a collaborative approach to data manipulation.

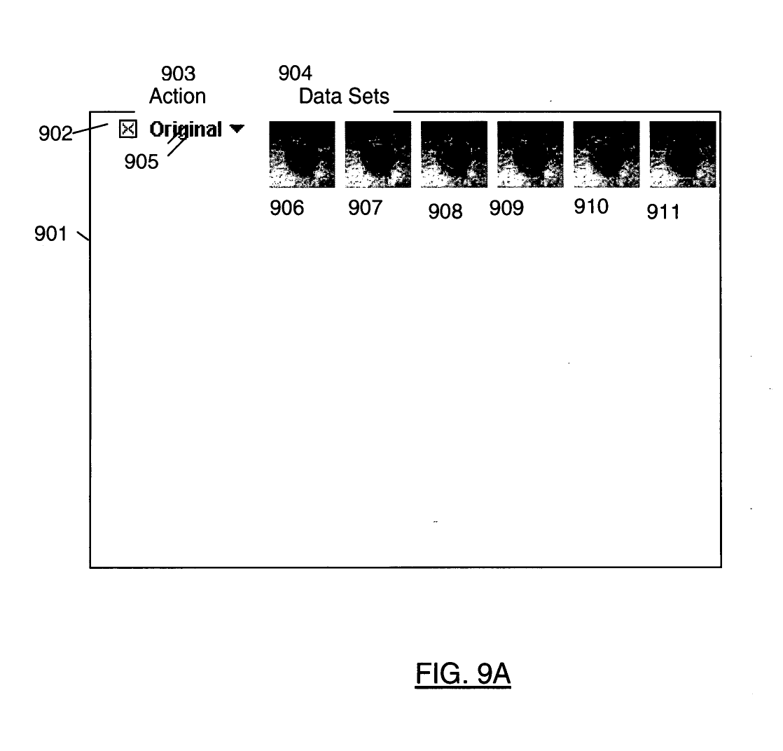

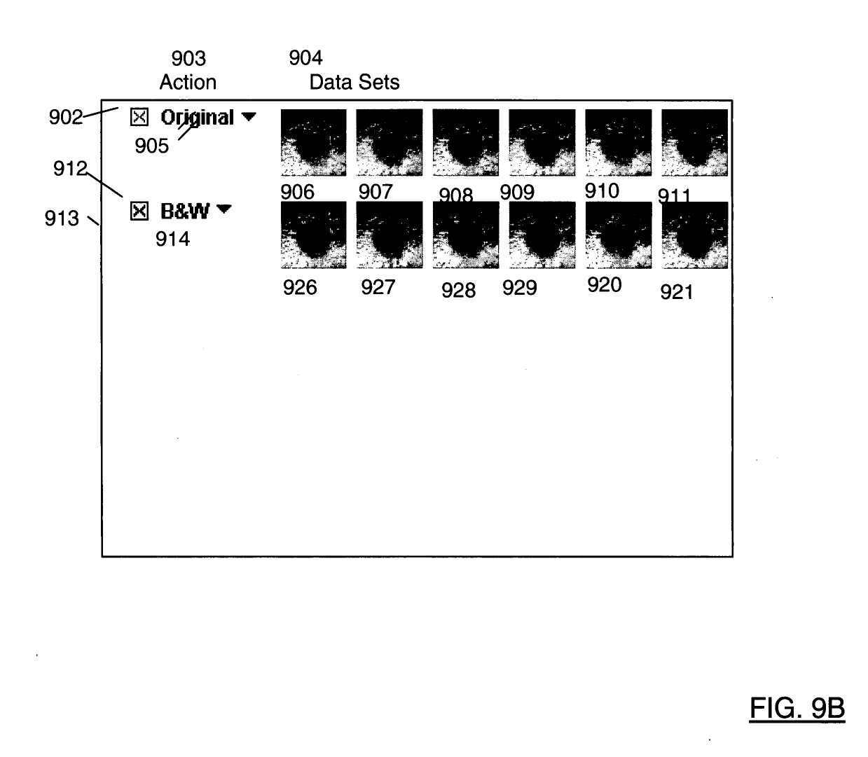

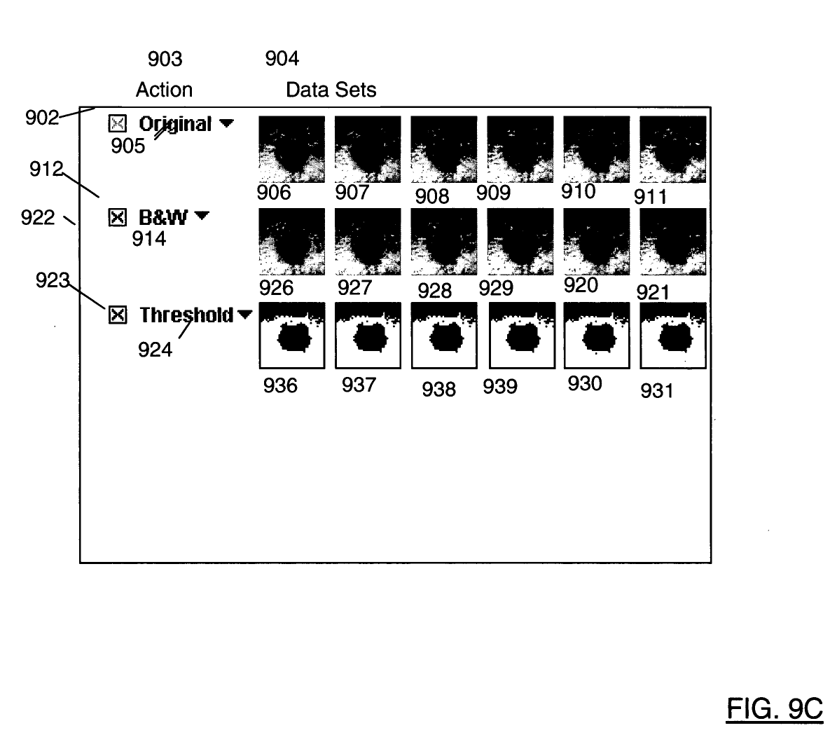

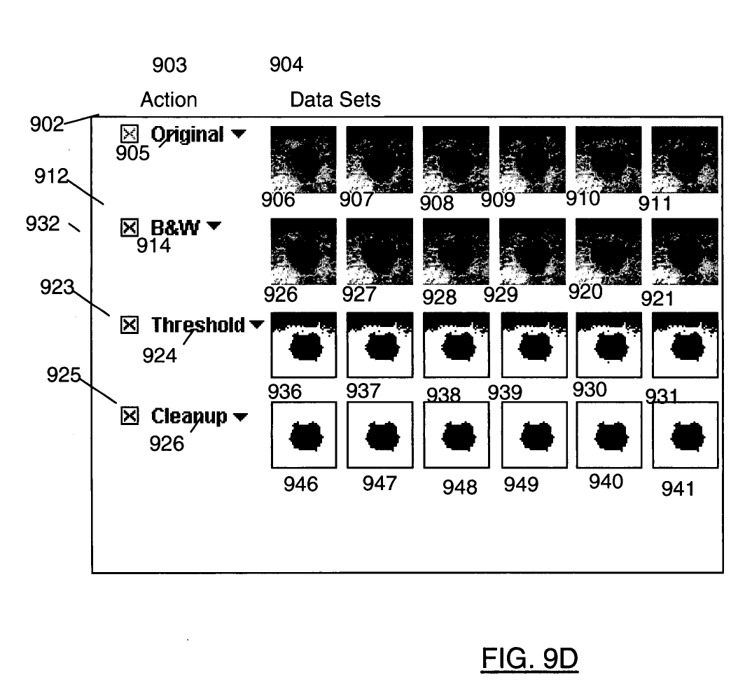

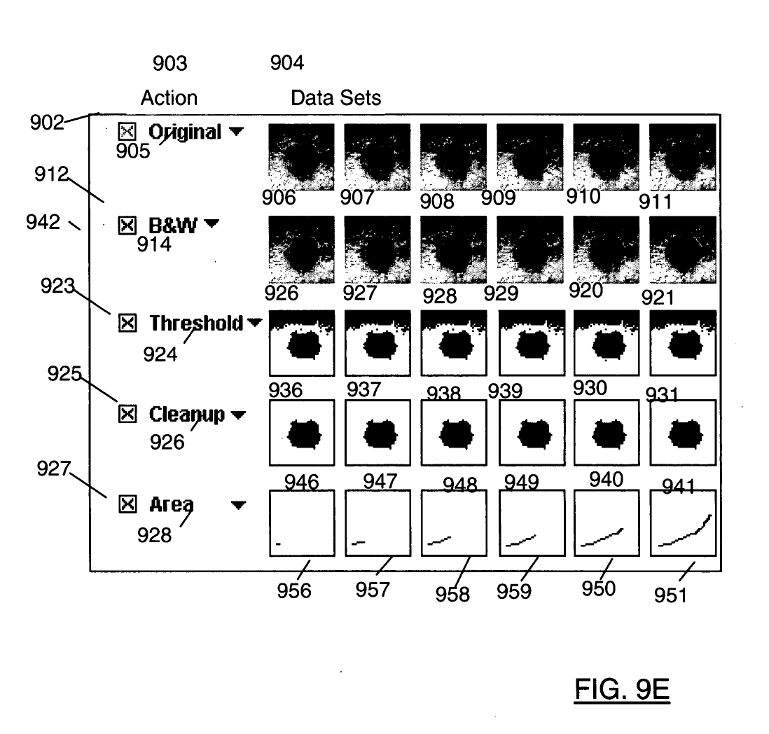

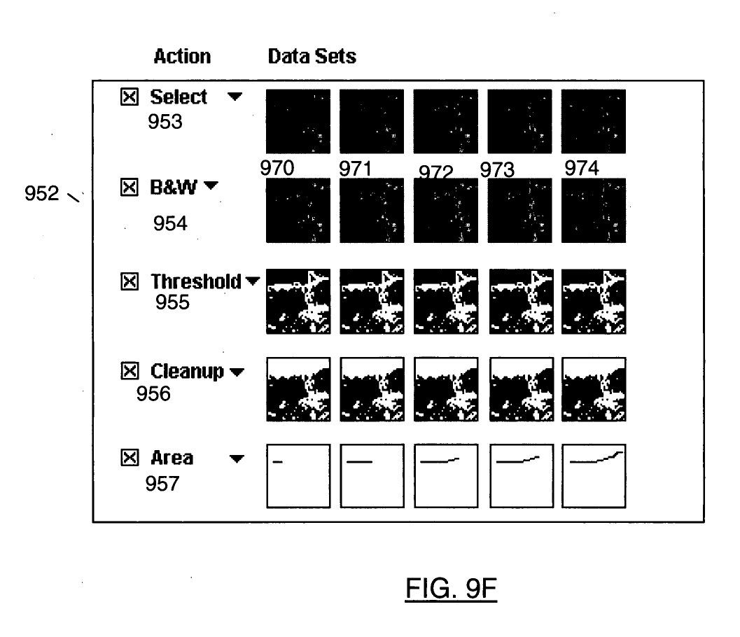

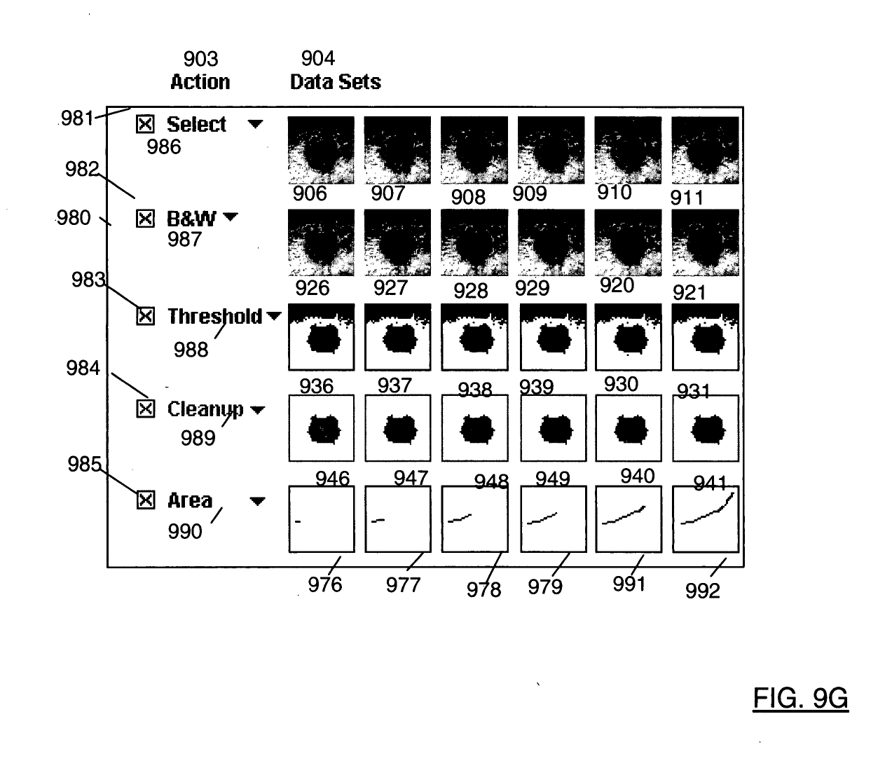

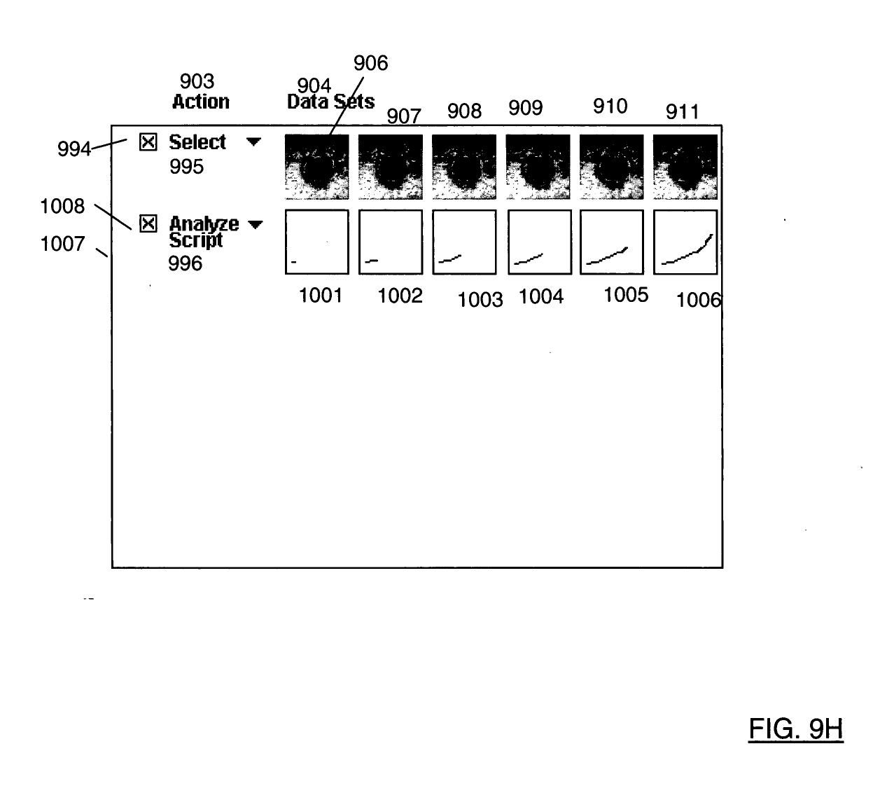

In the sequence of images in FIG. 9A-E, we see a user opening a series of images for editing. These figures present a visual history of the actions on a plurality of data files, in this case there are 6 data files each of which provides an image of a sequence of images. Alternatively, only one file need be the focus of the actions placed on the list. The list of actions performed are shown in a window 901 of a terminal display which includes a checkbox 902, an action 903 label to identify the action, and an optional representation 904 of the file (data set). The user selects a file(s) 906 907 908 909 910 911 for processing. In the example, the files 906 907 908 909 910 911 are images of a medical tumor taken in time sequence in order to determine the rate of growth of the tumor. The last image 911 may be larger or smaller than the first image taken 906. The user applies a sequence of processing steps on the original images 906 907 908 909 910 911. In a first action FIG. 9B a black and white rendering of the original color images is performed. the action is displayed as a “B&W” action 914 and the resulting images are displayed 926 927 928 929 920 921. Each “B&W” image 926 927 928 929 920 921 is rendered from the respective original color images 906 907 908 909 910 911 first selected. In a second action FIG. 9C a threshold filter operates on the “B&W” images 926 927 928 929 920 921 to eliminate gray tones. This threshold action 924 produces high contrast images 936 937 938 939 930 931. In a third action FIG. 9D, a “cleanup” action 925 is performed on the high contrast images 936 937 938 939 930 931 to remove extraneous information producing cleaner images 946 947 948 949 940 941 respectively. Finally an action FIG. 9E is performed that measures the size of the tumor by determining the amount of black in the images, the “Area” action 928 produces graphs 956 957 958 959 950 951 of each respective cleaned-up image 946 947 948 949 940 941. These actions 914 924 926 928 are recorded and any of them can be selectively removed from the sequence of calculations by clicking on the checkbox 905 914 924 926 928 905 associated with the action. This is demonstrated in FIG. 9G where the “Cleanup” action 989 is undone by having unchecked the checkbox 984 associated with it. This removes the action 989 from the sequence of actions. Thus, the “Area” action 990 produces a graph 976 977 978 979 991 992 of the corresponding high contrast images 936 937 938 939 930 931 ignoring the Cleaned-up images 946 947 948 949 940 941.

In one embodiment, the actions performed 914 924 926 928 on the selected 905 original data sets 906 907 908 909 910 911 are accumulated in an action history record. The action history record can then be programmably manipulated to modify the sequence of actions or the actions themselves by operating on the action history record. The final step modifies the file by replacing the contents of the image with data calculated from the image itself. This action is different than just modifying the contents of the file. The result of the history list is shown in FIG. 9E.

In another scenario, the user modifies the images with a number of actions, but then realizes that an additional action (the Threshold action 924) needs to be inserted into the list of actions to achieve the desired result. The user selects the Black and White action 914, and inserts the Threshold action. In the first attempt, the user decides that the settings for the threshold need to be adjusted. The user adjusts these properties. The resulting images are recalculated and are now acceptable. The user turns all of the active actions 914 924 926 928 into a script program module for future use. Only those actions that are enabled (in FIGS. 9A-9G, they have a check in the box) contribute to the creation of a script. The script then encapsulates this sequence as a saved action. Alternatively, the disabled actions can be included in the script, but remain inactive. The script can then be applied to other selected images in subsequent file processing. In the process of turning a history list into an action, all references to snapshots are removed while any disabled actions may also be removed. The remaining actions with their attributes are stored in a file to be applied in the future. FIG. 9H depicts the scripts being applied to the same data set. Here, the select action 995 selects the same images as before, however the action history list shows 1007 a single action, the script module being applied “Analyze Script” 996 resulting in data images 1001 1002 1003 1004 1005 1006.

FIG. 9F depicts 952 the actions 914 924 926 928 saved in the action history record being applied 954 955 956 957 to another selected 953 data set of images 970 971 972 973 974.

In the preceding example, the action history record is accumulated for a plurality of data records. The functionality of the present invention is not limited to operating on a plurality of data records, the invention is advantageous when applied to a single data record. Furthermore, multiple action history records may be created, one for each selected data record but presented as a composite in an alternative view.

One embodiment of the history list is a sequence of actions. This could be stored in binary or human readable text form. Each action is composed of a unique action id, a name, a set of attributes for that action, whether or not it is enabled, and a pointer to a snapshot if it exists for this action in the sequence of actions. In addition, any action may include text and other meta-data fields that allow the action to be used as a self-explanatory teaching aid. This text field is an annotation that explains the rationale for a given action in the sequence. In addition, when saving a set of actions, a general description for the whole action set can be used to describe the script. As actions are added to the sequence, they are appended to this list of actions. The history can be saved out and the history file can be used in a number of ways. It can move with the file and be reused when opening the original file. This set of actions can then be used to undo actions across editing sessions. In addition, it can be converted to a script by removing unnecessary data (references to snapshots and disabled actions). This script can then be applied to other files and in the process, its history will now mirror the saved script that was applied. In addition, the history file can provide meta-data about design decisions through the annotation facility. The annotations can provide other users with relevant information about the edit actions that are taking place in the file.

Any actions on the history list itself, such as enabling, disabling, adding, deleting, inserting, copying and pasting, can be viewed as modifying this list of data elements. For example, by deleting an action, the system first removes the action from the history list but then it needs to recalculate the file based on the revised history. This might mean going back to the original file and processing all the remaining enabled actions in the history list. Alternatively, the system could use a saved snapshot and then proceed forward adding any actions not already incorporated into the snapshot, while at the same time removing the newly deleted action and any disabled actions.

When the user disables an action, processing the file is the same as deleting an action as described above. However, the action remains in the list and can be re-enabled in the future. If re-enabled, its transformations would modify the file accordingly.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment of the invention has been illustrated and described herein, it is to be understood that the invention is not limited to the precise construction herein disclosed, and the right is “reserved” to all changes and modifications coming within the scope of the invention as defined in the appended claims.

What is claimed is:

1. A method for managing data record actions, the method comprising the steps of:
accumulating in a first action history record, a first sequence of actions performed on a first data record;
selecting one or more first actions from the first action history record; and
performing a manipulating operation on one or more of the first actions, the manipulating operation modifying the first sequence of actions to produce a second sequence of actions.

2. The method according to claim 1, comprising the further step of performing the second sequence of actions on the first data record to produce a second data record.

3. The method according to claim 2 comprising the further step of comprising any one of displaying the second data record, saving the second action history record or saving the second data record.

4. The method according to claim 2 comprising the further steps of:
creating a second action history record associated with the second data record, the second action history record for accumulating actions performed on the second data record;
saving the second data record; and
saving the second action history record.

5. The method according to claim 2 comprising the further step of saving the second sequence of actions as a third action history record.

6. The method according to claim 4 comprising the further step of:
creating a marker in the first action history record, the marker comprising information for locating the second action history record and the second data record.

7. The method according to claim 5 comprising the further step of:
creating index information for locating the second data record; and
saving index information in the first action history record.

8. The method according to claim 1, wherein the modifying operation performed comprises any one of the further steps consisting of:
moving a first action from a sequential position of the first sequence of actions to a new sequential position of the first sequence of actions,
inserting a second action into the first sequence of actions such that the third action comprises an action sequence preceding an action of the first sequence of actions,
inserting a program module into the first sequence of actions,
modifying the sequence of the first sequence of actions,
undoing one or more of the first actions, redoing one or more of the first actions, or
operating on one or more of the first actions, the operating step consisting of any one of:
enabling a first action,
disabling a first action,
adding a new action,
deleting a first action,
copying a first action,
pasting a first action,
changing the first action sequence,
modifying parameters of a first action, or
annotating an action.

9. The method according to claim 1, wherein the modifying operation is performed responsive to a GUI event.

10. The method according to claim 1, comprising the further step of:
selecting one or more actions of the group of first and second actions;
generating a program module reproducing effective functionality of the selected one or more actions; and
saving the generated program module.

11. The method according to claim 11 wherein the generated program module comprises a script.

12. The method according to claim 1, comprising the further steps of:
accumulating in the first action history record, the first sequence of actions performed on the first data record across sessions, the sessions comprising any one of a user session, a program session, a communications session or a computer session.

13. The method according to claim 1, comprising the further step of:
responsive to a GUI user action, performing an action of the first sequence of actions.

14. The method according to claim 1, comprising the further step of deploying the method from one or more first computer systems to one or more second computer systems.

15. A computer program product for managing data record actions, the computer program product comprising:
a storage medium readable by a processing circuit and storing instructions for execution by the processing circuit for performing a method comprising:
accumulating in a first action history record, a first sequence of actions performed on a first data record;
selecting one or more first actions from the first action history record; and
performing a manipulating operation on one or more of the first actions, the manipulating operation modifying the first sequence of actions to produce a second sequence of actions.

16. The computer program product according to claim 15 wherein the modifying operation performed comprises any one of the further steps consisting of:
moving a first action from a sequential position of the first sequence of actions to a new sequential position of the first sequence of actions,
inserting a second action into the first sequence of actions such that the third action comprises an action sequence preceding an action of the first sequence of actions,
inserting a program module into the first sequence of actions,
modifying the sequence of the first sequence of actions,
undoing one or more of the first actions, redoing one or more of the first actions, or
operating on one or more of the first actions, the operating step consisting of any one of:
enabling a first action,
disabling a first action,
adding a new action,
deleting a first action,
copying a first action,
pasting a first action,
changing the first action sequence,
modifying parameters of a first action, or
annotating an action.

17. The computer program product according to claim 15, comprising the further step of:
performing the second sequence of actions on the first data record to produce a second data record;
creating a second action history record associated with the second data record, the second action history record for accumulating actions performed on the second data record;
saving the second data record; and
creating any one of a marker or an index in the first action history record, any one of the marker or index comprising information for locating the second action history record and the second data record.

18. A system for managing data record actions, the system comprising:
a network;
a client system in communication with the network wherein the system includes instructions to execute a method comprising the steps of:
accumulating in a first action history record, a first sequence of actions performed on a first data record;
selecting one or more first actions from the first action history record; and
performing a manipulating operation on one or more of the first actions, the manipulating operation modifying the first sequence of actions to produce a second sequence of actions.

19. The system according to claim 18, wherein the modifying operation performed comprises any one of the further steps consisting of:
moving a first action from a sequential position of the first sequence of actions to a new sequential position of the first sequence of actions,
inserting a second action into the first sequence of actions such that the third action comprises an action sequence preceding an action of the first sequence of actions,
inserting a program module into the first sequence of actions,
modifying the sequence of the first sequence of actions,
undoing one or more of the first actions, redoing one or more of the first actions, or
operating on one or more of the first actions, the operating step consisting of any one of:
enabling a first action,
disabling a first action,
adding a new action,
deleting a first action,
copying a first action,
pasting a first action,
changing the first action sequence,
modifying parameters of a first action, or
annotating an action.

20. The system according to claim 18, comprising the further step of:
performing the second sequence of actions on the first data record to produce a second data record;
creating a second action history record associated with the second data record, the second action history record for accumulating actions performed on the second data record;
saving the second data record; and
creating any one of a marker or an index in the first action history record, any one of the marker or index comprising information for locating the second action history record and the second data record.
